(19) United States
(12) Patent Application Publication
(10) Pub. No.: US 2026/0332009 A1
(43) Pub. Date: Oct. 22, 2026

(54) TAPING MACHINE AND TAPING METHOD

(71) Applicant: NITTOKU Co., Ltd., Saitama-city, Saitama (JP)

(72) Inventor: Yuki FUKUYA, Fukushima-shi, Fukushima (JP)

(73) Assignee: NITTOKU Co., Ltd., Saitama-city, Saitama (JP)

(21) Appl. No.: 19/158,357

(22) PCT Filed: Feb. 19, 2024
(86) PCT No.: PCT/JP2024/005827

§ 371 Date: Aug. 20, 2025

(30) Foreign Application Priority Data
Feb. 21, 2023 (JP) 2023-024908

(51) Int. Cl. H02K 15/04; B65H 81/06

(52) U.S. Cl. CPC H02K 15/04; B65H 81/06; B65H 2801/72

(57) ABSTRACT

The taping machine includes: the plurality of the dies respectively formed with the insertion holes through which the wire rod, to which the adhesive tape is preliminary affixed such that the side portion of the adhesive tape stands up from the wire rod, is passed; and the cutouts respectively formed in the plurality of the dies so as to open the insertion holes, the cutouts being configured to allow entry of the side portion of the adhesive tape, wherein the side portion of the adhesive tape is affixed to the outer circumference of the wire rod by sequentially passing the wire rod, to which the adhesive tape is preliminary affixed, to the plurality of the insertion holes of the dies.

### TECHNICAL FIELD

The present invention relates to a taping machine and a taping method for affixing an adhesive tape to an outer circumference of a wire rod.

### BACKGROUND ART

As a stator of a conventional motor (an electric motor), there is known a stator in which a plurality of divided cores, around each of which a coil is wound, are arranged in an annular pattern, and crossover wires are formed by connecting the wire rod extending from each coil. JP2010-58857A discloses a taping machine for affixing, when the crossover wire is to be formed, an insulating adhesive tape to the wire rod forming the crossover wire in order to protect the crossover wire and ensure an insulating property thereof.

The taping machine includes: a taping table on which a back surface of the adhesive tape is placed; tape suction ports that guide a negative pressure to the taping table; a tape draw-in groove that opens to the taping table; and a chuck mechanism that clamps the adhesive tape. In the taping machine, the back surface of the adhesive tape is sucked onto the taping table by the negative pressure, the wire rod is drawn into the tape draw-in groove together with the adhesive tape, and both end portions of the adhesive tape, which has been affixed to the wire rod along the longitudinal direction, are adhered to each other by the chuck mechanism.

### SUMMARY OF INVENTION

However, when both of the end portions of the adhesive tape, which has been affixed to the wire rod along the longitudinal direction, are adhered to each other, the adhered portion does not have a function of protecting the wire rod and undesirably becomes a surplus portion. In addition, when a bending force is imparted to the wire rod to which the adhesive tape is affixed, there is also risk in that a base of the surplus portion is damaged.

An object of the present invention is to provide a taping machine and a taping method capable of affixing an adhesive tape to a wire rod without forming a surplus portion.

According to one aspect of the present invention, a taping machine for affixing an adhesive tape to a wire rod, the taping machine includes: a plurality of dies respectively formed with insertion holes through which the wire rod, to which the adhesive tape is preliminary affixed such that a side portion of the adhesive tape stands up from the wire rod, is passed; and cutouts respectively formed in the plurality of dies so as to open the insertion holes, the cutout being configured to allow entry of the side portion of the adhesive tape, wherein the plurality of dies are arranged such that the insertion holes are linked continuously in a length direction of the wire rod and such that the cutouts are displaced from each other in a circumferential direction of the insertion holes, and the side portion of the adhesive tape is affixed to an outer circumference of the wire rod by relatively moving the wire rod and the plurality of dies, and by causing the wire rod, to which the adhesive tape is preliminary affixed, to sequentially pass through the insertion holes of the plurality of dies.

According to another aspect of the present invention, a taping method for affixing an adhesive tape to a wire rod includes: a tape preliminary-affixing step of preliminary affixing the adhesive tape to the wire rod such that both side portions of the adhesive tape stand up from the wire rod; a first affixing step of affixing a first side portion of the adhesive tape to an outer circumference of the wire rod by causing the wire rod, to which the adhesive tape is preliminary affixed, to pass through an insertion hole formed in an upstream-side die; and a second affixing step of affixing a second side portion of the adhesive tape on the first side portion, which is affixed to the outer circumference of the wire rod, by causing the wire rod, which is passed through the upstream-side die and to which the adhesive tape is preliminary affixed, to pass through an insertion hole formed in a downstream-side die.

### BRIEF DESCRIPTION OF DRAWINGS

FIG. 1 is an exploded perspective view showing a taping machine according to an embodiment of the present invention.

FIG. 2 is a sectional view taken along line E-E in FIG. 11 showing a linkage state of a plurality of dies.

FIG. 3 is a sectional view taken along line A-A in FIG. 2 showing a first top die.

FIG. 4 is a sectional view taken along line B-B in FIG. 2 showing a second die.

FIG. 5 is a sectional view taken along line C-C in FIG. 2 showing a third die.

FIG. 6 is a sectional view taken along line D-D in FIG. 2 showing a fourth die.

FIG. 7 is a sectional view taken along line F-F in FIG. 11 showing steps of preliminary affixing an adhesive tape to a wire rod in chronological order.

FIG. 8 is a plan view showing steps of placing the adhesive tape to a taping table in chronological order.

FIG. 9 is a diagram showing a connected coil obtained by a winding device.

FIG. 10 is a plan view showing the winding device.

FIG. 11 is a front view showing the winding device.

### DESCRIPTION OF EMBODIMENTS

In the following, an embodiment of the present invention will be described with reference to the drawings.

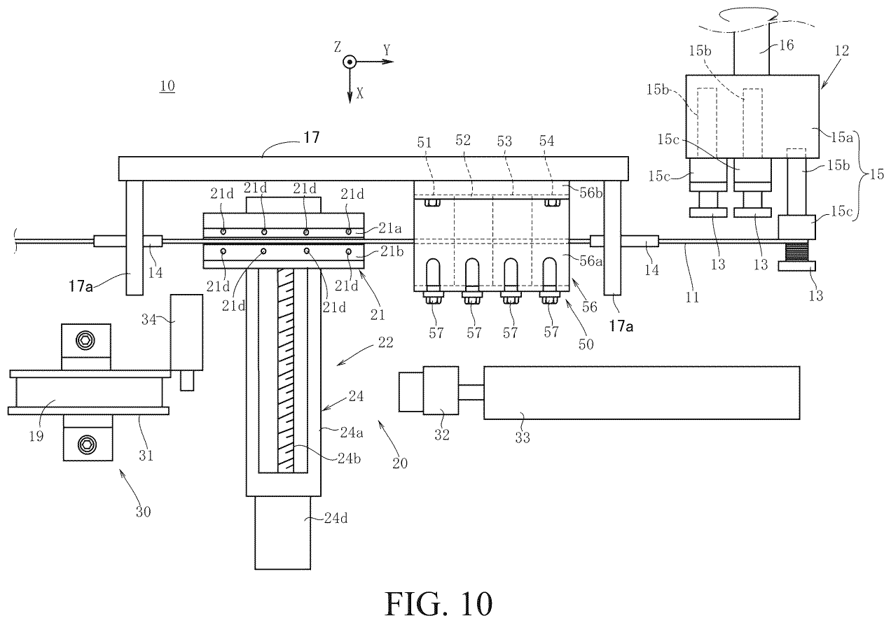

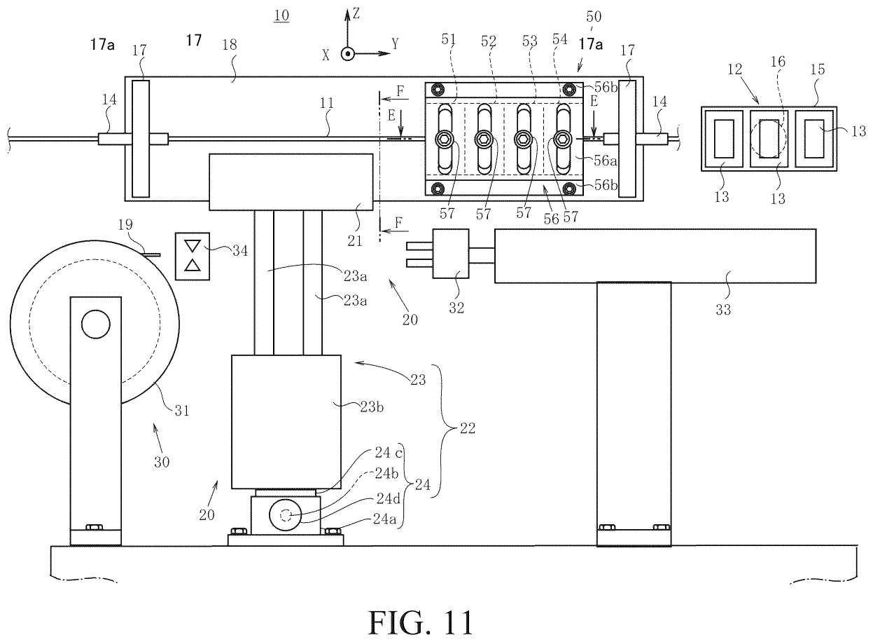

FIGS. 10 and 11 show a winding device 10 that includes a taping machine 50 according to an embodiment of the present invention. In the drawings, three axes X, Y, and Z that are mutually orthogonal are set, and the description will be made by stating that the X axis extends in the horizontal front-rear direction, the Y axis extends in the horizontal transverse direction, and the Z axis extends in the vertical direction.

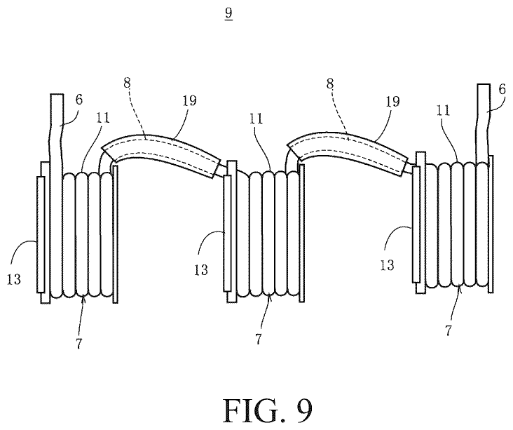

The winding device 10 includes a winding machine 12 that winds a wire rod 11 supplied from a wire rod source (not shown) in the Y axis direction around divided cores 13. The winding machine 12 forms, for example, a three-phase coupling coil 9 (see FIG. 9) that forms a stator (an multipole armature) of a three-phase AC motor, and includes a spindle 16 having a winding core 15, which holds three divided cores 13, at its tip end.

As shown in FIG. 10, the winding core 15 has: a main body 15a that is attached to the tip end of the spindle 16; three in/out shafts 15b that are provided so as to extend in parallel to the spindle 16 from the main body 15a; and holding tools 15c that are respectively attached to tip ends of the in/out shafts 15b and respective hold the divided cores 13 around which the wire rod 11 is to be wound.

In the winding machine 12, when the spindle 16 is rotated together with the main body 15a in a state in which one of the in/out shafts 15b is projected out from the main body 15a, the wire rod 11 that has been delivered from the wire rod source and passed through nozzles 14 is wound around only the divided core 13 that is held by the projected out in/out shaft 15b.

As shown in FIGS. 10 and 11, a pair of nozzles 14 that guide the wire rod 11 are provided so as to be spaced apart in a coaxial manner. The pair of nozzles 14 are provided so as to respectively penetrate through mounting plates 17a. Two mounting plates 17a are connected by a connecting plate 17. By moving the connecting plate 17 by a nozzle moving mechanism (not shown), it is possible to move the pair of nozzles 14 in three axial directions while maintaining the state in which the nozzles 14 are spaced apart.

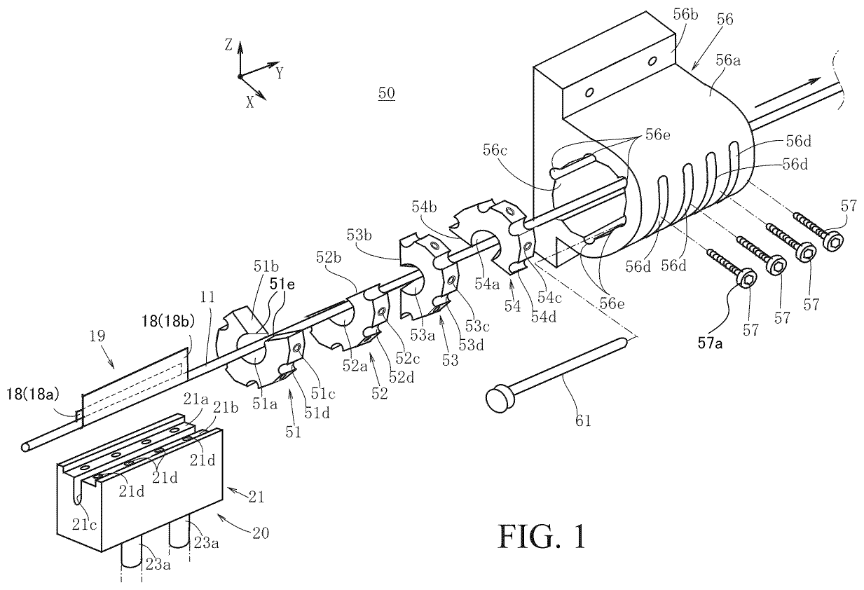

The winding device 10 includes a tape preliminary-affixing machine 20 that preliminary affixes adhesive tape 19 having a predetermined length (FIG. 1) on the wire rod 11 supplied from the wire rod source. The tape preliminary-affixing machine 20 includes: a taping table 21 onto which the adhesive tape 19 having a predetermined length is sucked; a table moving mechanism 22 that moves the taping table 21 between a tape-loading position and a tape preliminary affixing position; and a tape supply device 30 that supplies the adhesive tape 19 to the taping table 21 at the tape-loading position.

As shown in FIG. 1, the taping table 21 is formed with tape placing portions 21a and 21b on which a back surface of the adhesive tape 19 is placed and a tape draw-in groove 21c that opens between the tape placing portions 21a and 21b. The taping table 21 is formed to have a rectangular shape in plan view, a shallow groove is formed in an upper surface of the taping table 21, and the tape placing portions 21a and 21b are formed as a bottom surface of this shallow groove.

A plurality of tape suction ports 21d are formed on each of the tape placing portions 21a and 21b. Vacuum tubes, through which a negative pressure source (not shown) is communicated with the tape suction ports 21d, are respectively connected to the taping table 21. As the negative pressure is guided to each of the tape suction ports 21d, the back surface of the adhesive tape 19 that is placed on the tape placing portions 21a and 21b is sucked to the tape placing portions 21a and 21b. With such a configuration, the adhesive tape 19 is prevented from falling off from the tape placing portions 21a and 21b.

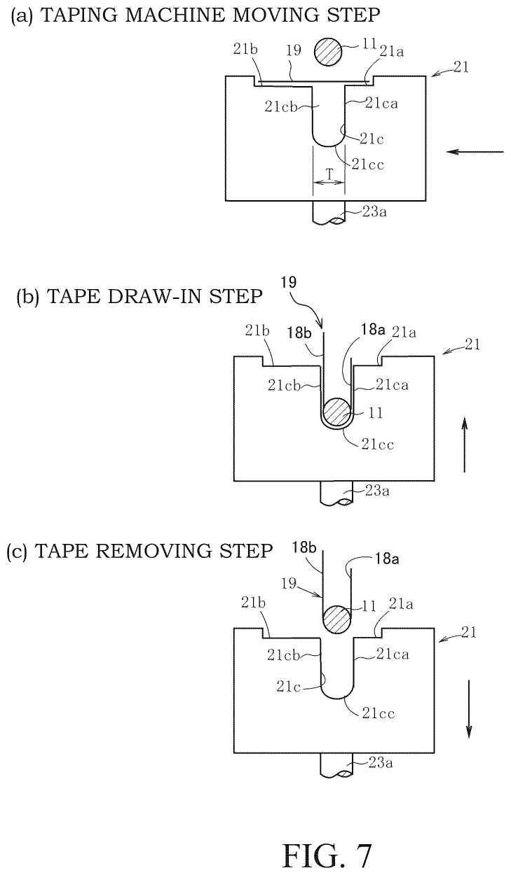

As shown in FIG. 7, the tape draw-in groove 21c is formed so as to extend perpendicularly with respect to the tape placing portions 21a and 21b. In this embodiment, the width dimensions (the dimension in the direction perpendicular to the length direction of the wire rod 11) of the tape placing portion 21a and the tape placing portion 21b, which are respectively formed on both sides of the tape draw-in groove 21c, are different. Specifically, the width of the tape placing portion 21a is narrower than the width of the tape placing portion 21b.

The tape draw-in groove 21c has flat groove side surfaces 21ca and 21cb that face each other in parallel with an opening width T and a groove bottom portion 21cc that connects the groove side surfaces 21ca and 21cb and is curved to have an arc shaped cross-section. The opening width T is set to the sum of the outer diameter of the wire rod 11, twice the thickness of the adhesive tape 19, and a predetermined clearance.

As shown in FIGS. 10 and 11, the table moving mechanism 22 includes a vertical direction actuator 23 that moves the taping table 21 in the vertical direction and an X-axis-direction actuator 24 that moves the taping table 21 in the X axis direction by moving the vertical direction actuator 23 in the X axis direction.

As shown in FIG. 11, the vertical direction actuator 23 is a fluid pressure cylinder having a main body 23b and an in/out rod 23a that is supported by the main body 23b and is moved in the vertical direction. The X-axis-direction actuator 24 has: a housing 24a that is provided so as to extend in the X axis direction; a rotation shaft 24b that is provided inside the housing 24a and has an external thread; a movable body 24c that is screwed to the external thread of the rotation shaft 24b and is movable along the housing 24a; and a driving source 24d that rotates the rotation shaft 24b.

As the driving source 24d, for example, a servomotor that can be controlled with a high accuracy is used. The main body 23b of the vertical direction actuator 23 is attached to the movable body 24c that is moved along the housing 24a.

By rotating the rotation shaft 24b by driving the driving source 24d of the X-axis-direction actuator 24, the movable body 24c and the vertical direction actuator 23 are moved between the position below the tape preliminary affixing position and the tape-loading position.

The tape supply device 30 includes: a reel 31 around which the adhesive tape 19 is wound; a chuck 32 that clamps the adhesive tape 19 extending from the reel 31; a driving cylinder 33 that moves the chuck 32; a cutter 34 that cuts the adhesive tape 19; and a moving mechanism (not shown) that moves the cutter 34.

The operation of the tape supply device 30 is controlled on the basis of a command from a controller (not shown). Specifically, the chuck 32 draws out the adhesive tape 19 from the reel 31, and the drawn-out adhesive tape 19 is placed on the tape placing portions 21a and 21b of the taping table 21. Thereafter, the cutter 34 cuts the adhesive tape 19 into a predetermined length. As a result, a piece of the adhesive tape 19 cut in this manner is placed on the taping table 21 so as to be capable of being held by suction.

Next, the table moving mechanism 22 moves the taping table 21 from the tape-loading position, at which the adhesive tape 19 having a predetermined length is placed on the tape placing portions 21a and 21b, to the tape preliminary affixing position, at which the adhesive tape 19 is preliminary affixed to the wire rod 11.

In this embodiment, as shown in FIG. 7, because the tape draw-in groove 21c is formed in the taping table 21, as the wire rod 11 is drawn into the tape draw-in groove 21c, the adhesive tape 19 is also drawn into the tape draw-in groove 21c together with the wire rod 11. As the wire rod 11 enters the tape draw-in groove 21c, the adhesive tape 19, which is held on the taping table 21 by suction, is preliminary affixed to the wire rod 11 along the longitudinal direction, and both side portions 18 of the adhesive tape 19 extend linearly so as to stand up from the wire rod 11. Specifically, both side portions 18 of the adhesive tape 19 extend in parallel to each other in the tangential direction with respect to an outer circumferential surface of the wire rod 11.

In this embodiment, the width dimensions of the tape placing portion 21a and the tape placing portion 21b, which are respectively formed on both sides of the tape draw-in groove 21c are different from each other, and so, the standing length of a first side portion 18a of the adhesive tape 19 that is preliminary affixed to the wire rod 11 is shorter than that of a second side portion 18b. As described above, the side portions 18 of the adhesive tape 19 are formed of the side portion 18a whose length from the wire rod 11 is shorter as compared to the side portion 18b and the side portion 18b whose length from the wire rod 11 is longer as compared to the side portion 18a.

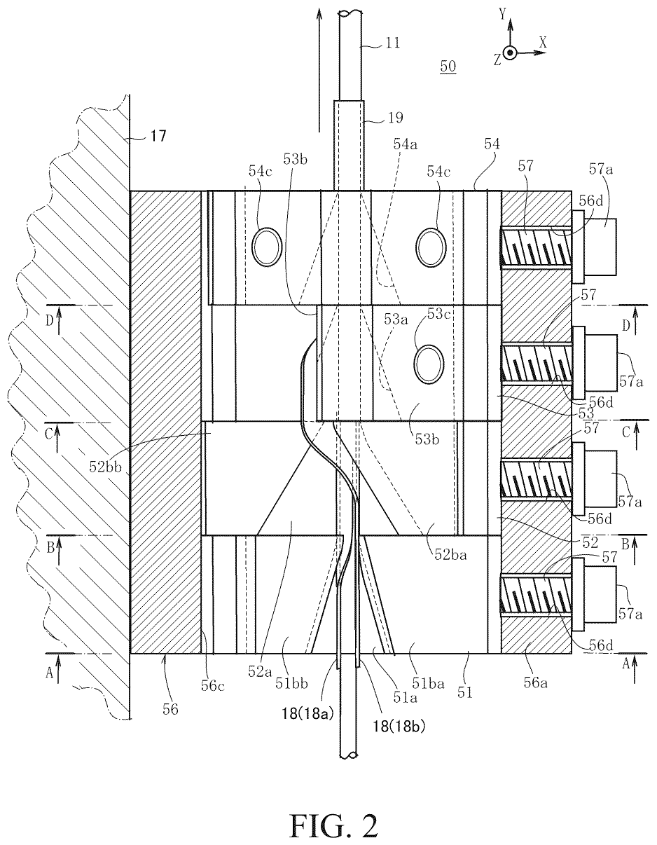

As shown in FIGS. 1 and 2, the wire rod 11, to which the adhesive tape 19 having a predetermined length is preliminary affixed by the tape preliminary-affixing machine 20, is subsequently allowed to pass through the taping machine 50. The taping machine 50 in this embodiment includes a plurality of dies 51, 52, 53, and 54 respectively formed with insertion holes 51a, 52a, 53a, and 54a, through which the wire rod 11 moving in the length direction passes.

The plurality of dies 51, 52, 53, and 54 affix the adhesive tape 19 to the outer circumference of the wire rod 11 by causing the adhesive tape 19 that is preliminary affixed to the wire rod 11 along the length direction (along the Y axis direction) to pass through a plurality of insertion holes 51a, 52a, 53a, and 54a together with the wire rod 11. The plurality of dies 51, 52, 53, and 54 in this embodiment are each formed to have a disc shape, and respectively have substantially the same outer diameter and substantially the same thickness.

In this embodiment, the insertion holes 51a, 52a, 53a, and 54a of the plurality of dies 51, 52, 53, and 54 respectively penetrate through the centers of dies 51, 52, 53, and 54, and are each formed to have a circular cross-section with the diameter decreasing toward the moving direction of the wire rod 11. The smallest diameter (the diameter at an exit portion) of each of the insertion holes 51a, 52a, 53a, and 54a in downstream side end surfaces of the dies 51, 52, 53, and 54 is set to be the sum of the outer diameter of the wire rod 11, the thickness of the adhesive tape 19 affixed to the outer circumference of the wire rod 11, and a predetermined clearance. In this embodiment, in the die 51 located on the most upstream side, a single layer of the adhesive tape 19 is affixed to the wire rod 11, and in the dies 52, 53, and 54 located on the downstream side of the die 51, two layers of the adhesive tape 19 are affixed to the wire rod 11. Thus, the diameters of the insertion holes 52a, 53a, and 54a in the downstream side end surfaces of the dies 52, 53, and 54 are larger than the diameter of the insertion hole 51a in the downstream side end surface of the die 51.

With such a configuration, the adhesive tape 19 is, together with the wire rod 11, drawn into the insertion holes 51a, 52a, 53a, and 54a of the plurality of the dies 51, 52, 53, and 54 sequentially, and as the adhesive tape 19 passes through the die 54 located on the most downstream side, the adhesive tape 19 is affixed to the outer circumference of the wire rod 11.

The plurality of the dies 51, 52, 53, and 54 are respectively formed with cutouts 51b, 52b, 53b, and 54b that form openings to the insertion holes 51a, 52a, 53a, and 54a. The cutouts 51b, 52b, 53b, and 54b are formed to extend from the insertion holes 51a, 52a, 53a, and 54a to the outer circumferential surfaces of the dies 51, 52, 53, and 54, and formed so as to extend over the entire length of the dies 51, 52, 53, and 54 in the axial direction. The cutouts 51b, 52b, 53b, and 54b are each formed to allow the entrance of the side portion 18 standing up from the wire rod 11 of the adhesive tape 19 that is preliminary affixed to the wire rod 11.

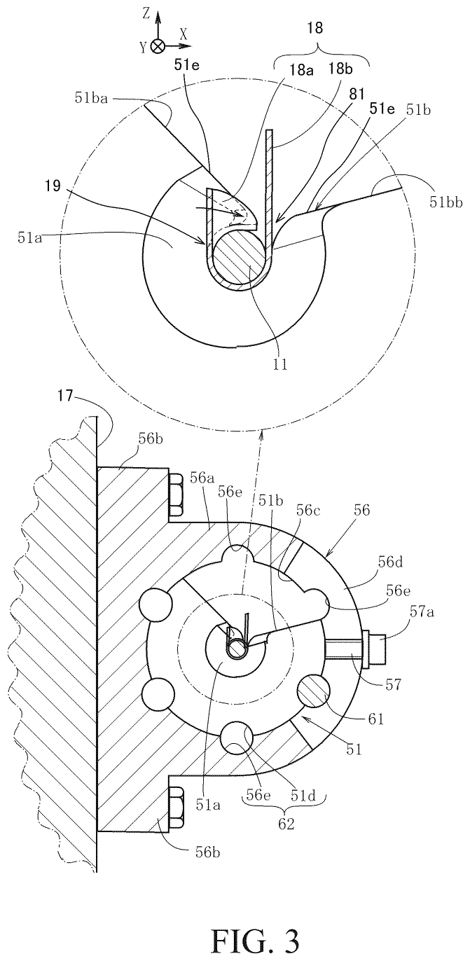

As shown in FIGS. 3 to 6, the cutout 51b, 52b, 53b, 54b has two cutout surfaces 51ba, 52ba, 53ba, 54ba and 51bb, 52bb, 53bb, 54bb. In other words, the cutout 51b, 52b, 53b, 54b is formed between the cutout surface 51ba, 52ba, 53ba, 54ba and the cutout surface 51bb, 52bb, 53bb, 54bb. Thus, the insertion hole 51a, 52a, 53a, 54a opens between the cutout surface 51ba, 52ba, 53ba, 54ba and the cutout surface 51bb, 52bb, 53bb, 54bb. The cutout surface 51ba, 52ba, 53ba, 54ba and the cutout surface 51bb, 52bb, 53bb, 54bb are each a plane parallel to the moving direction of the wire rod 11 (the length direction). In this embodiment, the plane including the cutout surface 51ba, 52ba, 53ba, 54ba and the plane including the cutout surface 51bb, 52bb, 53bb, 54bb do not include the center of the insertion hole 51a, 52a, 53a, 54a. In other words, the cutout surface 51ba, 52ba, 53ba, 54ba and the cutout surface 51bb, 52bb, 53bb, 54bb do not coincide with the plane extending in the radial direction (the radiating direction) of the insertion hole 51a, 52a, 53a, and 54a.

The insertion hole 51a, 52a, 53a, 54a is formed to have a circular cross-section with the diameter decreasing toward the moving direction of the wire rod 11. In other words, the insertion hole 51a, 52a, 53a, 54a has a conical shape. Therefore, intersection lines 51e, 52e, 53e, 54e between the cutout 51b, 52b, 53b, 54b and the insertion hole 51a, 52a, 53a, 54a (inner edges of the cutout surface 51ba, 52ba, 53ba, 54ba and the cutout surface 51bb, 52bb, 53bb, 54bb) are formed such that the gap distance between them becomes shorter toward the moving direction of the wire rod 11.

In this embodiment, in the first die 51, the angle formed by the cutout surfaces 51ba and 51bb is less than 180 degrees, and the cutout 51b is formed to have a fan shaped cross-section. In each of the second die 52, the third die 53, and the fourth dies 54, the angle formed by the cutout surface 52ba, 53ba, 54ba and the cutout surface 52bb, 53bb, 54bb is approximately 180 degrees.

In this embodiment, the cutout surface 51ba, 52ba, 53ba, 54ba and the cutout surface 51bb, 52bb, 53bb, 54bb, which are the planes parallel to the moving direction of the wire rod 11, do not coincide with the plane extending in the radial direction (the radiating direction) of the insertion hole 51a, 52a, 53a, 54a, and so, the cutout surface 51ba, 52ba, 53ba, 54ba and the cutout surface 51bb, 52bb, 53bb, 54bb do not intersect with the insertion hole 51a, 52a, 53a, 54a on the downstream side end surface of the die 51, 52, 53, 54. However, a rounding process is performed such that the cutout surface 51ba, 52ba, 53ba, 54ba and the cutout surface 51bb, 52bb, 53bb, 54bb smoothly continue to the inner circumference of the insertion hole 51a, 52a, 53a, 54a. Therefore, the insertion hole 51a, 52a, 53a, 54a opens smoothly over the entire length through the cutout 51b, 52b, 53b, 54b, and so, the wire rod 11 and the adhesive tape 19 are prevented from being damaged when the wire rod 11 and the adhesive tape 19 pass through the die 51, 52, 53, 54.

The cutout surface 51ba, 52ba, 53ba, 54ba and the cutout surface 51bb, 52bb, 53bb, 54bb may coincide with the plane extending in the radial direction of the insertion hole 51a, 52a, 53a, 54a. However, as in this embodiment, if the cutout surface 51ba, 52ba, 53ba, 54ba and the cutout surface 51bb, 52bb, 53bb, 54bb do not coincide with the plane extending in the radial direction of the insertion hole 51a, 52a, 53a, 54a, the degree of freedom of the shape of the cutout 51b, 52b, 53b, 54b becomes greater. As a result, the cutout 51b, 52b, 53b, 54b can be formed to have an optimal shape, and so, it is possible to guide the side portions 18 of the adhesive tape 19 to the outer circumference of the wire rod 11 efficiently and stably.

As shown in FIGS. 1 and 2, the taping machine 50 includes a holder 56 that accommodates the plurality of the dies 51, 52, 53, and 54 in a stacked state such that the insertion holes 51a, 52a, 53a, and 54a are linked continuously in the length direction of the wire rod 11. The holder 56 has a mounting portion 56b and a cylindrical member 56a that is formed with a round hole 56c having an inner diameter slightly larger than the outer diameters of the dies 51, 52, 53, and 54. The round hole 56c accommodates the disc-shaped dies 51, 52, 53, and 54 rotatably. The holder 56 is attached to the connecting plate 17 via the mounting portion 56b (see FIGS. 10 and 11).

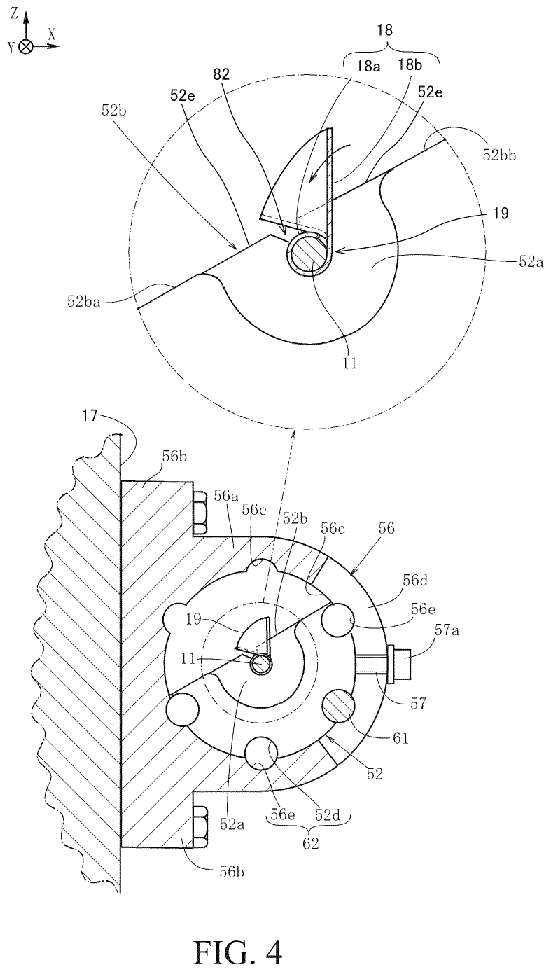

The plurality of the dies 51, 52, 53, and 54 accommodated in the holder 56 are arranged such that the insertion holes 51a, 52a, 53a, and 54a are linked continuously and such that the adjacent dies among them come into contact in a state in which their cutouts 51b, 52b, 53b, and 54b are displaced from each other in the circumferential direction. As shown in FIGS. 2 to 6, the amount of displacement in the circumferential direction between the adjacent dies among the dies 51, 52, 53, and 54 are set such that the side portion 18 of the adhesive tape 19 is smoothly guided between the adjacent dies. Specifically, the amount of displacement in the circumferential direction between the adjacent dies is set such that an opening portion (the reference numeral 81 in FIG. 3 for the die 51) of the insertion hole that opens to the cutout at the downstream end surface of the die on the upstream side is positioned within an opening portion (the reference numeral 82 in FIG. 4 for the die 52) of the insertion hole that opens to the cutout at the upstream end surface of the die located on the downstream side. With such a configuration, the side portion 18 of the adhesive tape 19 that has passed through the opening portion of the insertion hole at the downstream end surface of the die on the upstream side is smoothly guided to the opening portion of the insertion hole at the upstream end surface of the die located on downstream side.

The cylindrical member 56a is formed with elongated holes 56d extending in the circumferential direction so as to correspond to the dies 51, 52, 53, and 54 accommodated in the cylindrical member 56a. In the outer circumferences of the dies 51, 52, 53, and 54, female screw holes 51c, 52c, 53c, and 54c are respectively formed, and male screws 57 respectively inserted into the elongated holes 56d are respectively screwed into the female screw holes 51c, 52c, 53c, and 54c. The male screws 57 respectively screwed into the female screw holes 51c, 52c, 53c, and 54c restrict the rotation of the dies 51, 52, 53, and 54 relative to the holder 56 by screw heads 57a coming into contact with the periphery of the elongated holes 56d. The male screws 57 are fixtures serving as fixing means for fixing the plurality of the dies 51, 52, 53, and 54, which are accommodated in the round hole 56c, to the holder 56.

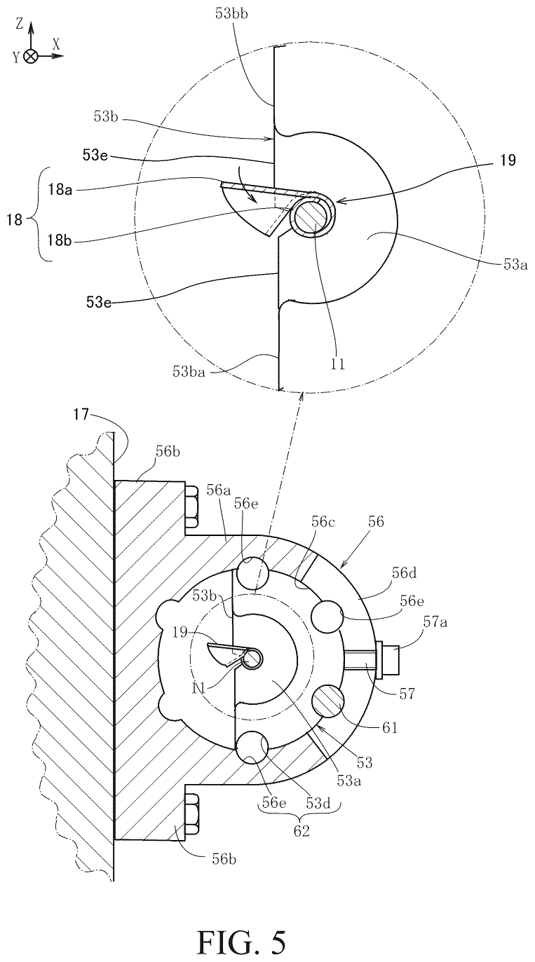

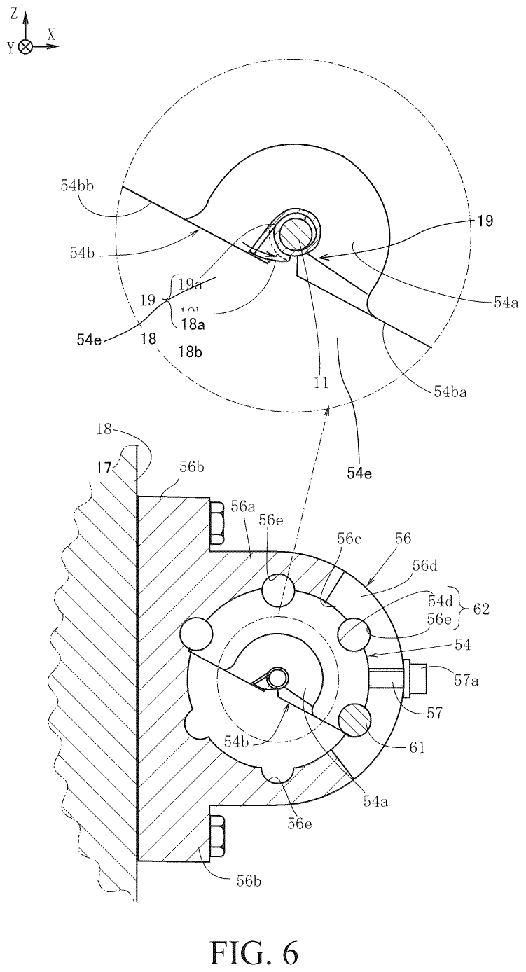

The plurality of the dies 51, 52, 53, and 54 are arranged in the holder 56 by being linked in a state in which respective cutouts 51b, 52b, 53b, and 54b are displaced from each other in the circumferential direction. In this embodiment, the standing lengths of both side portions 18a and 18b of the adhesive tape 19 are different. The first die 51 located on the most upstream side affixes the first side portion 18a of the adhesive tape 19 having a shorter standing length to the outer circumference of the wire rod 11 (see FIG. 3). The second and third dies 52 and 53 sequentially guide the second side portion 18b of the adhesive tape 19 having a longer standing length such that the second side portion 18b is overlapped with the first side portion 18a that has already been affixed to the wire rod 11 (see FIGS. 4 and 5). The fourth die 54 located on the most downstream side affixes the second side portion 18b of the adhesive tape 19 to the first side portion 18a, which has already been affixed to the outer circumference of the wire rod 11, in an overlapped manner (see FIG. 6). The single die 51 located on the most upstream side corresponds to an upstream-side die, and the plurality of dies 52, 53, and 54 that are arranged on the downstream side of the die 51 correspond to downstream-side dies. It should be noted that the downstream-side dies may be configured of a single die.

In this embodiment, both sides of the adhesive tape 19 is caused to stand up in the Z axis direction by the tape preliminary-affixing machine 20. As shown in FIG. 3, the die 51 located on the most upstream side is accommodated in the holder 56 in a state in which the cutout 51b is angled toward the side portion 18b of the adhesive tape 19 having a longer standing length. With such a configuration, the side portion 18b enters and passes through the cutout 51b. Meanwhile, the side portion 18a having shorter standing length is affixed to the outer circumference of the wire rod 11 so as to extend along the outer circumference by the inner circumference of the insertion hole 51a.

As shown in FIGS. 4 and 5, the second and third dies 52 and 53 are accommodated in the holder 56 in a state in which the cutouts 52b and 53b are angled toward the side portion 18a of the adhesive tape 19 having a shorter standing length. The dies 52 and 53 are arranged so as to be displaced from each other by 60 degrees in the circumferential direction. With such a configuration, as the side portion 18b having longer standing length enters the cutouts 52b and 53b, its entry length is shortened gradually, and at the same time, the side portion 18b is guided and affixed to the outer side of the side portion 18a, which has already been affixed to the wire rod 11, so as to be overlapped therewith.

As shown in FIG. 6, the die 54 located on the most downstream side is accommodated in the holder 56 in a state in which the cutout 54b is angled toward the side portion 18a such that the side portion 18b cannot enter the cutout 54b. Specifically, the die 54 is arranged so as to be displaced from the die 53 by 60 degrees in the circumferential direction. With such a configuration, the side portion 18b is affixed on the side portion 18a, which has already been affixed to the wire rod 11, so as to be overlapped therewith by the inner circumference of the insertion hole 54a of the die 54.

In the present embodiment, the dies 51, 52, 53, and 54 are rotatably accommodated in the round hole 56c of the holder 56. Therefore, pins 61 that restrict the rotation of the dies 51, 52, 53, and 54 in the round hole 56c are provided. The pins 61 are respectively inserted into through holes 62 that are formed across the inner circumference of the round hole 56c and the outer circumferences of the dies 51, 52, 53, and 54.

The plurality of the dies 51, 52, 53, and 54, which are accommodated in the holder 56 in a overlapped configuration so as not be rotatable by the pins 61, function to affix both side portions 18a and 18b of the adhesive tape 19 to the outer circumference of the wire rod 11.

The inner circumference of the round hole 56c is formed with recessed grooves 56e extending in the passing direction of the wire rod 11. The outer circumference of the die 51, 52, 53, 54 is formed with opposing grooves 51d, 52d, 53d, 54d that respectively oppose to the recessed grooves 56e in a state in which the die 51, 52, 53, 54 is accommodated in the round hole 56c. The through holes 62, into which the pins 61 are respectively inserted, are formed by the recessed grooves 56e and the opposing grooves 51d, 52d, 53d, and 54d.

In this embodiment, the cross-sectional shapes of the recessed groove 56e and the opposing groove 51d, 52d, 53d, 54d are each formed to have a semicircular shape such that the through hole 62 has a circular cross-sectional shape. The pins 61 each have a circular cross-sectional shape.

The plurality of the dies 51, 52, 53, and 54 are arranged so as to be displaced by equal angles in the circumferential direction. A plurality of recessed grooves 56e are formed in the inner circumference of the round hole 56c at intervals in the circumferential direction. Specifically, the plurality of recessed grooves 56e are formed at equal angular intervals with respect to the central axis of the round hole 56c. In this embodiment, the second, third, and fourth dies 52, 53, and 54 are arranged so as to be displaced by 60 degrees each, and so, the recessed grooves 56e are formed at six positions, each spaced by 60 degrees, with respect to the central axis of the round hole 56c.

Because the through holes 62, through which the pins 61 are respectively inserted, are formed every 60 degrees in the inner circumference of the round hole 56c of the holder 56, it is possible to arrange the dies 51, 52, 53, and 54 in a state displaced by 60 degrees so as not to be rotatable.

Next, manufacturing of the coupling coil 9 by the winding device 10 including the taping machine 50 will be described.

As shown in FIG. 9, the coupling coil 9 is formed of a plurality of coils 7 connected by crossover wires 8. Because the winding device 10 (see FIGS. 10 and 11) includes the winding machine 12 having three winding cores 15, the manufactured coupling coil 9 has three coils 7 formed of three divided cores 13 around which the wire rod 11 is wound, two crossover wires 8 connecting adjacent coils 7, and lead wires 6 respectively extending from the coils 7 on both ends.

The adhesive tape 19 having an insulating property is affixed to each of the crossover wires 8 of the coupling coil 9. The manufacture of the coupling coil 9 is performed by sequentially repeating a winding step and a taping step after a winding preparation step for preparing the winding device 10. These steps will be described in detail below.

### Winding Preparation Step

In the winding preparation step, as shown in FIG. 1, selection of the plurality of the dies 51, 52, 53, and 54 and fixing of the holder 56 in the taping machine 50 are carried out.

The plurality of the dies 51, 52, 53, and 54 are selected such that the insertion holes 51a, 52a, 53a, and 54a having optimal size are formed in accordance with the wire rod 11 to be used for the winding, the thickness of the adhesive tape 19, and so forth. The thus-selected plurality of the dies 51, 52, 53, and 54 are accommodated in the holder 56 such that the insertion holes 51a, 52a, 53a, and 54a are linked continuously in the length direction of the wire rod 11 and such that the cutouts 51b, 52b, 53b, and 54b are displaced from each other in the circumferential direction.

In this embodiment, because the through holes 62 are formed across the inner circumference of the round hole 56c of the holder 56 and the outer circumferences of the dies 51, 52, 53, and 54, by respectively inserting the pins 61 into the through holes 62 in a state in which the cutouts 51b, 52b, 53b, and 54b of the dies 51, 52, 53, and 54 are displaced in the circumferential direction, the rotation of the dies 51, 52, 53, and 54 is restricted. As a result, the displacement between adjacent dies among the dies 51, 52, 53, and 54 is set to an optimum displacement.

By respectively screwing the male screws 57 into the female screw holes 51c, 52c, 53c, and 54c in the dies 51, 52, 53, and 54 through the elongated holes 56d of the holder 56, the dies 51, 52, 53, and 54 are fixed to the holder 56.

In a case in which the displacement of the dies 51, 52, 53, and 54 in the circumferential direction needs to be adjusted finely, the pins 61 are removed from the through holes 62 and the male screws 57 are loosened to allow slight rotation of the dies 51, 52, 53, and 54 in the circumferential direction. In this state, the positions of the dies 51, 52, 53, and 54 in the circumferential direction are finely adjusted, and the male screws 57 are respectively screwed into the female screw holes 51c, 52c, 53c, and 54c of the dies 51, 52, 53, and 54 again to fix the dies 51, 52, 53, and 54 to the holder 56.

As described above, the plurality of the dies 51, 52, 53, and 54 are accommodated and fixed in the holder 56 in the overlapped configuration.

Next, as shown in FIGS. 10 and 11, the wire rod 11 is delivered from the wire rod source, passed through the nozzle 14 on the upstream side, and then inserted through the insertion holes 51a, 52a, 53a, and 54a of the plurality of the dies 51, 52, 53, and 54 held in the holder 56. At this time, the wire rod 11 may be guided to the insertion holes 51a, 52a, 53a, and 54a through the cutouts 51b, 52b, 53b, and 54b.

Thereafter, the wire rod 11 that has passed through the insertion holes 51a, 52a, 53a, and 54a of the dies 51, 52, 53, and 54 is guided to the winding machine 12 through the nozzle 14 on the downstream side, and anchored to an anchoring pin (not shown). This anchoring is performed by anchoring an end portion of the wire rod 11 to the anchoring pin (not shown) by moving the nozzle 14. Thereafter, the winding step is started.

### Winding Step

In the winding step, as shown in FIG. 10, the wire rod 11 is wound around the divided cores 13 by the winding machine 12 to form the coils 7 (see FIG. 9). In the winding machine 12, the three holding tools 15c that respectively hold the three divided cores 13 are provided. When the wire rod 11 is to be wound around a first divided core 13, the in/out shaft 15b including the holding tool 15c that holds the divided core 13, around which the wire rod 11 is to be wound, is caused to project out from the main body 15a, and in this state, the spindle 16 is rotated together with the main body 15a.

As a result, it is possible to wind the wire rod 11 only around the divided core 13 that is attached to the holding tool 15c on the tip end of the projected in/out shaft 15b. During this winding step, by moving the nozzle 14 in the X axis direction, the wire rod 11 is wound around the rotating divided core 13 in an aligned pattern.

By winding the wire rod 11 around the divided core 13 the desired number of times, the coil 7 is formed (see FIG. 9). After the coil 7 is formed, the rotation of the spindle 16 is stopped to prevent further winding of the wire rod 11. As a result, a portion of the wire rod 11 extending from the anchoring pin (not shown) to the coil 7 becomes the lead wire 6 at the start of winding (see FIG. 9).

### Taping Step

In the taping step, the insulating adhesive tape 19 having a predetermined length is affixed to a portion of the wire rod 11 that forms the crossover wire 8 (see FIG. 9). The adhesive tape 19 having a predetermined length is preliminary affixed to the portion of the wire rod 11 that forms the crossover wire 8 by the tape preliminary-affixing machine 20. Thereafter, in the taping machine 50, the adhesive tape 19 that is preliminary affixed to the wire rod 11 is affixed to the wire rod 11 so as to be wound around the wire rod 11.

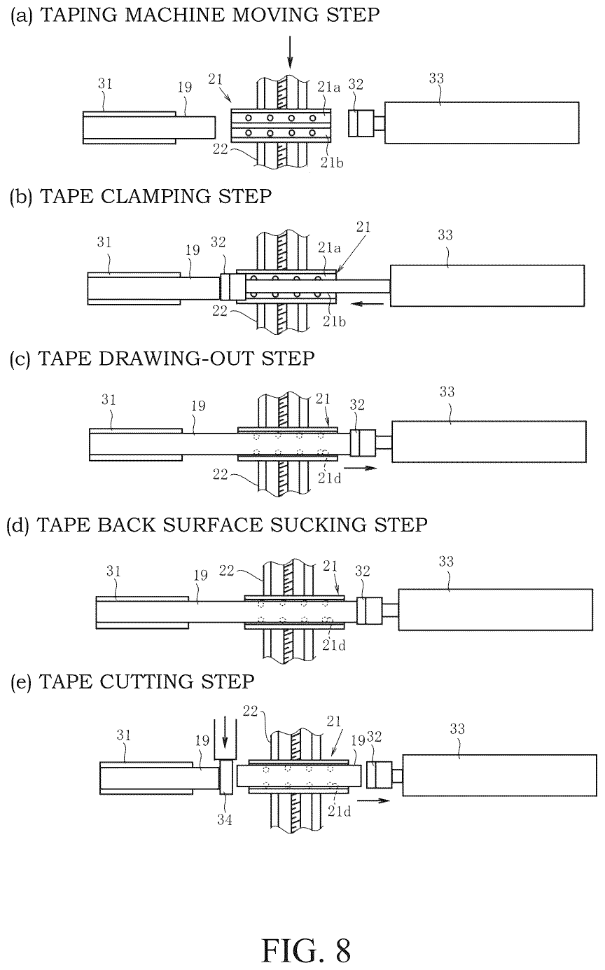

A tape preliminary-affixing step of preliminary affixing the adhesive tape 19 to the wire rod 11 by the tape preliminary-affixing machine 20 will be described. As shown in FIG. 8(a), the taping table 21 is moved to the tape-loading position by the table moving mechanism 22, and in this state, the adhesive tape 19 of a desired length is held by suction on the taping table 21 by the tape supply device 30.

Specifically, as shown in FIG. 8(b), the driving cylinder 33 is extended, and the chuck 32 clamps a tip end portion of the adhesive tape 19 extending from the reel 31. Thereafter, as shown in FIG. 8(c), the driving cylinder 33 is contracted, and the chuck 32 draws out the adhesive tape 19 from the reel 31. The drawn-out adhesive tape 19 is placed so as to extend above the tape placing portions 21a and 21b.

Next, as shown in FIG. 8(d), the table moving mechanism 22 moves the taping machine 50 upward in the Z axis direction, places the drawn-out adhesive tape 19 on the tape placing portions 21a and 21b, and causes the back surface of the adhesive tape 19 to be sucked onto the tape placing portions 21a and 21b by the negative pressure guided to the tape suction ports 21d. Thereafter, as shown in FIG. 8(e), the adhesive tape 19 is cut by the cutter 34, and the chuck 32 releases the tip end portion of the adhesive tape 19. As described above, the adhesive tape 19 having a predetermined length is held by suction on the taping table 21.

Next, the taping table 21 is moved to a tape affixing position, and the adhesive tape 19 placed on the taping table 21 is affixed to the wire rod 11.

Specifically, as shown in FIG. 7(a), the taping table 21 is moved to the tape affixing position. At the tape affixing position, the tape draw-in groove 21c of the taping table 21 is caused to face the wire rod 11 extending between the pair of nozzles 14 (see FIG. 10).

Thereafter, as shown in FIG. 7(b), the taping table 21 is moved upward in the Z axis direction, and the wire rod 11 is inserted into the tape draw-in groove 21c. As a result, the adhesive tape 19 placed on the tape placing portions 21a and 21b is drawn into the tape draw-in groove 21c by the wire rod 11.

As a result, the adhesive tape 19 is folded into a J-shaped cross-section, and the back surface of the adhesive tape 19 is pressed against the groove bottom portion 21cc of the tape draw-in groove 21c, and thereby, an adhesive surface of the adhesive tape 19 is affixed to a lower part of the outer circumferential surface of the wire rod 11.

Thereafter, as shown in FIG. 7(c), the taping table 21 is moved downward in the Z axis direction, and the wire rod 11 to which the adhesive tape 19 is affixed is removed from the tape draw-in groove 21c. As described above, the adhesive tape 19 is preliminary affixed to the wire rod 11. Next, the taping table 21 is moved to an escape position away from the winding machine 12, which is a position where an interference does not occur with the nozzles 14 that reciprocate in the X axis direction in the winding step.

As described above, when the wire rod 11 is inserted into the tape draw-in groove 21c, both side portions 18a and 18b of the adhesive tape 19 stand up along both sides of the wire rod 11. In this embodiment, because the width dimensions of the tape placing portion 21a and the tape placing portion 21b, which are respectively formed on both sides of the tape draw-in groove 21c, are different from each other, the adhesive tape 19 that is preliminary affixed to the wire rod 11 forms the J-shaped cross-section in which the standing length of the side portion 18a is shorter than the standing length of the side portion 18b.

Next, as shown in FIG. 2, the wire rod 11, to which the adhesive tape 19 has been preliminary affixed, is passed through the plurality of the insertion holes 51a, 52a, 53a, and 54a of the dies 51, 52, 53, and 54, and thereby, the preliminary affixed adhesive tape 19 is affixed to the outer circumference of the wire rod 11.

The wire rod 11 may be passed through the insertion holes 51a, 52a, 53a, and 54a of the dies 51, 52, 53, and 54 by winding the wire rod 11 around the divided core 13, or by moving the holder 56, in which the dies 51, 52, 53, and 54 are accommodated, in a state in which the delivery of the wire rod 11 is stopped. In other words, the wire rod 11 is passed through the insertion holes 51a, 52a, 53a, and 54a of the dies 51, 52, 53, and 54 by relatively moving moving the wire rod 11 and the dies 51, 52, 53, and 54.

As shown in FIG. 1, because the side portions 18 of the adhesive tape 19 stand up from the wire rod 11, the side portions 18 cannot pass through the insertion holes 51a, 52a, 53a, and 54a.

However, because the cutouts 51b, 52b, 53b, and 54b that respectively open the insertion holes 51a, 52a, 53a, and 54a are formed in the dies 51, 52, 53, and 54, respectively, the wire rod 11, to which the adhesive tape 19 is preliminary affixed, is allowed to pass through the insertion holes 51a, 52a, 53a, and 54a by causing the side portions 18 of the adhesive tape 19 to enter the cutouts 51b, 52b, 53b, and 54b.

In this embodiment, because the plurality of the dies 51, 52, 53, and 54 are linked such that the cutouts 51b, 52b, 53b, and 54b are displaced in the circumferential direction, the side portions 18 of the adhesive tape 19 that have entered the cutouts 51b, 52b, 53b, and 54b are guided by the cutouts 51b, 52b, 53b, and 54b and affixed around the wire rod 11. Specific description thereof will be described below.

As shown in FIG. 3, the cutout 51b of the first die 51 is formed so as to be displaced in the circumferential direction toward the side portion 18b of the adhesive tape 19 having a longer standing length. In addition, the intersection lines 51e between the cutout 51b and the insertion hole 51a are formed such that a gap distance between them is reduced toward the moving direction of the wire rod 11. Therefore, the side portion 18a of the adhesive tape 19 having a shorter standing length that has entered the cutout 51b is guided so as to fall toward the outer circumference of the wire rod 11 by coming into contact with the intersection line 51e between the cutout 51b and the insertion hole 51a (specifically, the intersection line 51e between the cutout surface 51ba and the insertion hole 51a) after it entered the insertion hole 51a, and thereby, the side portion 18a is pressed against and affixed to the outer circumference of the wire rod 11 by the inner circumference of the insertion hole 51a. Meanwhile, the side portion 18b of the adhesive tape 19 enters the cutout 51b, passes through the cutout 51b while maintaining its shape, and enters the cutout 52b of the second die 52. In this embodiment, the side portion 18a enters the cutout 51b of the die 51 located on the most upstream side and comes into contact with the intersection line 51e. However, the side portion 18a may be configured so as to be pressed against and affixed to the outer circumference of the wire rod 11 by the inner circumference of the insertion hole 51a without entering the cutout 51b. The affixing of the side portion 18a of the adhesive tape 19 to the wire rod 11 by the die 51 is a first affixing step. Although the first affixing step is performed by the single die 51 in this embodiment, it may be performed by a plurality of dies. However, because the side portion 18a is shorter than the side portion 18b, the affixing can be sufficiently achieved by the single die 51 in the first affixing step.

As shown in FIG. 4, the cutout 52b of the second die 52 is formed so as to be displaced in the circumferential direction toward the side portion 18a of the adhesive tape 19. In addition, the intersection lines 52e between the cutout 52b and the insertion hole 52a are formed such that a gap distance between them is reduced toward the moving direction of the wire rod 11. Therefore, the side portion 18b of the adhesive tape 19 having a longer standing length that has entered the cutout 52b is guided so as to fall toward the outer circumference of the wire rod 11 by coming into contact with the intersection line 52e between the cutout 52b and the insertion hole 52a (specifically, the intersection line 52e between the cutout surface 52bb and the insertion hole 51a). As a result, while the entry length of the side portion 18b into the cutout 52b is gradually shortened, the side portion 18b is affixed to the side portion 18a, which has already been affixed to the wire rod 11, so as to be overlapped with the outer side of the side portion 18a.

When the side portion 18b of the adhesive tape 19 passes through the die 52, the side portion 18b then enters the cutout 53b of the third die 53 from the cutout 52b of the die 52 together with the wire rod 11.

As shown in FIG. 5, the cutout 53b of the third die 53 is formed so as to be displaced in the circumferential direction by 60 degrees from the cutout 52b of the die 52 toward the side portion 18a of the adhesive tape 19. In addition, the intersection lines 53e between the cutout 53b and the insertion hole 53a are formed such that a gap distance between them is reduced toward the moving direction of the wire rod 11. Therefore, the side portion 18b of the adhesive tape 19 that has entered the cutout 53b is guided so as to fall toward the outer circumference of the wire rod 11 by coming into contact with the intersection line 53e between the cutout 53b and the insertion hole 53a (specifically, the intersection line 53e between the cutout surface 53bb and the insertion hole 53a). As a result, while the entry length of the side portion 18b into the cutout 53b is gradually shortened, the side portion 18b is affixed to the side portion 18a, which has already been affixed to the wire rod 11, so as to be further overlapped with the outer side of the side portion 18a.

When the side portion 18b of the adhesive tape 19 passes through the die 53, the side portion 18b then enters the insertion hole 54a of the fourth die 54 located on the most downstream side from the cutout 53b of the die 53 together with the wire rod 11. As shown in FIG. 6, the cutout 54b of the die 54 is formed so as to be displaced in the circumferential direction by 60 degrees from the cutout 53b of the die 53 toward the side portion 18a of the adhesive tape 19. The side portion 18b of the adhesive tape 19 is affixed to the side portion 18a, which has already been affixed to the wire rod 11, so as to be further overlapped with the outer side of the side portion 18a by the inner circumference of the insertion hole 54a without entering the cutout 54b. As a result, the side portion 18b of the adhesive tape 19 is affixed onto the side portion 18a entirely. Next, the adhesive tape 19 passes through the insertion hole 54a of the die 54 in a state in which both side portions 18a and 18b are affixed to the outer circumference of the wire rod 11. Note that, in this embodiment, the side portion 18b does not enter the cutout 54b of the die 54 located on the most downstream side. However, the side portion 18b may be configured to enter the cutout 54b, to be guided so as to fall toward the outer circumference of the wire rod 11 by coming into contact with the intersection line 54e between the cutout 54b and the insertion hole 54a (specifically, the intersection line 54e between the cutout surface 54bb and the insertion hole 54a), and thereafter, to be affixed to the outer side of the side portion 18a by the inner circumference of the insertion hole 54a. The affixing of the side portion 18b of the adhesive tape 19 to the wire rod 11 by the dies 52, 53, and 54 is a second affixing step. In this embodiment, although the second affixing step is performed by three dies 52, 53, and 54, the number of dies is not limited to three and may be performed by a single die. However, because the side portion 18b is longer than the side portion 18a, it is possible to better affix the side portion 18b to the wire rod 11 by performing the second affixing step in a plurality of steps using a plurality of dies.

As described above, the adhesive tape 19 is affixed to the portion of the wire rod 11 that forms the crossover wire 8 so as to be wound around the wire rod 11 by the taping machine 50. The crossover wire 8, to which the adhesive tape 19 is affixed, can be wound around a guide pin (not shown) formed on the main body 15a of the winding core 15.

Thereafter, the winding step of winding the wire rod 11 around next divided core 13 is performed, and thereafter, the taping step of affixing the adhesive tape 19 to the portion of the wire rod 11 that forms the crossover wire 8 is performed again. By repeatedly performing the winding step and the taping step in this manner, the coupling coil 9, as shown in FIG. 9, in which three coils 7 are connected via two crossover wires 8, is formed. By cutting the wire rod 11 extending from the third coil 7 to the nozzle 14, a portion of the wire rod 11 between the third coil 7 and the nozzle 14 becomes the lead wire 6 at the end of winding.

With the coupling coil 9 shown in FIG. 9 manufactured as described above, when the coupling coil 9 is assembled to a stator of a motor, the insulating property of the crossover wire 8 is sufficiently ensured by the adhesive tape 19.

A taping operation of the adhesive tape 19 to the wire rod 11 is automatically performed by preliminary affixing the adhesive tape 19 having a predetermined length to each of the portions of the wire rod 11 that respectively form the crossover wires 8 by the tape preliminary-affixing machine 20, and by allowing the wire rod 11, to which the adhesive tape 19 is preliminary affixed, to pass through the plurality of the dies 51, 52, 53, and 54 of the taping machine 50. As described above, the taping operation of the adhesive tape 19 to the wire rod 11 can be performed automatically without manual intervention, and so, it is possible to improve the productivity of the coupling coil 9.

In addition, because all of the adhesive tape 19 that is preliminary affixed to the wire rod 11 is affixed by being wound around the wire rod 11, a surplus portion of the adhesive tape 19 that is not protecting the wire rod 11 is not formed. Therefore, because the adhesive tape 19 is affixed so as to wrap the wire rod 11, the insulating property of the wire rod 11 is ensured sufficiently. In addition, because there is no surplus portion, even if a bending force is imparted to the crossover wire 8, which is the wire rod 11 to which the adhesive tape 19 is affixed, the adhesive tape 19 is prevented from being torn.

In this embodiment, in a tape preliminary-affixing step, the adhesive tape 19 is preliminary affixed to the wire rod 11 so as to form the J-shaped cross-section such that the standing length of the side portion 18a becomes shorter than the standing length of the side portion 18b. Therefore, it becomes possible to affix the side portion 18a of the adhesive tape 19 having a shorter standing length to the outer circumference of the wire rod 11 simply by causing the side portion 18a to pass through the insertion hole 51a of the single die 51. Consequently, an increase in size of the taping machine 50 is suppressed, and so, it is possible to attach the taping machine 50 even to conventional winding machines with limited installation space.

The affixing of the adhesive tape 19 that is preliminary affixed to the wire rod 11 to the wire rod 11 is performed by causing it to pass through the plurality of the dies 51, 52, 53, and 54, which are arranged so as to be offset mutually in the circumferential direction, and an affixed amount achieved by a single die is determined by the amount of displacement between the dies in the circumferential direction. In this embodiment, the holder 56 has the round hole 56c that rotatably accommodates the dies 51, 52, 53, and 54 and includes the male screws 57 each serving as the fixture for fixing the dies 51, 52, 53, and 54, which are accommodated in the round hole 56c, to the holder 56, and so, it is possible to fix the dies 51, 52, 53, and 54 to the holder 56 by the male screws 57 after fine adjustment of the amount of displacement of the dies 51, 52, 53, and 54 in the circumferential direction. As described above, it is possible to finely adjust the rotational positions of the dies 51, 52, 53, and 54.

When the adjustment of the rotational positions of the dies 51, 52, 53, and 54 is not required, it is possible to make the plurality of the dies 51, 52, 53, and 54 non-rotatable in the holder 56 by respectively inserting the pins 61 into the through holes 62, which are formed across the inner circumference of the round hole 56c of the holder 56 and the outer circumferences of the dies 51, 52, 53, and 54.

In the above-mentioned embodiment, a description has been given of a case in which the preliminary affixing of the adhesive tape 19 to the wire rod 11 is performed by the tape preliminary-affixing machine 20 including the taping table 21, and the back surface of the adhesive tape 19 is sucked by the negative pressure guided to the taping table 21.

However, as long as the alignment of the adhesive tape 19 with respect to the wire rod 11 can be performed accurately and the adhesive tape 19 can be accurately affixed to the wire rod 11, the preliminary affixing of the adhesive tape 19 to the wire rod 11 may be performed without placing the back surface of the adhesive tape 19 on the taping table 21. In addition, even if the adhesive tape 19 is placed on the taping table 21, the adhesive tape 19 may be held by clamping members without being sucked using the negative pressure.

In addition, in the above-mentioned embodiment, a description has been given of a case in which four dies 51, 52, 53, and 54 are used, the adhesive tape 19 is preliminary affixed to the wire rod 11 so as to form the J-shaped cross-section, and the first side portion 18a is affixed to the outer circumference of the wire rod 11 by the single die 51 in the first affixing step.

However, if there is no limitation on installation space and the taping machine 50 can be made to have a relatively large size, more than four dies may also be used. In addition, the adhesive tape 19 may also be preliminary affixed to the wire rod 11 so as to form a U-shaped cross-section in which the standing lengths of the side portion 18a and side portion 18b of the adhesive tape 19 are the same. Furthermore, the adhesive tape 19 may be preliminary affixed to the wire rod 11 such that only one of the side portions 18 of the adhesive tape 19 stands up from the wire rod 11. In this case, the die 51 in this embodiment is not required.

In addition, in the above-mentioned embodiment, the angle formed by the cutout surfaces 51ba and 51bb of the first die 51 is approximately 120 degrees, and the angles respectively formed by the cutout surfaces 52ba and 52bb of the second die 52, the cutout surfaces 53ba and 53bb of the third die 53, and the cutout surfaces 54ba and 54bb of the fourth die 54 are approximately 180 degrees. However, as long as the adhesive tape 19 can be affixed to the outer circumference of the wire rod 11, the opening angles of the cutouts 51b, 52b, 53b, and 54b of the dies 51, 52, 53, and 54 are not limited to these angles. For example, all of the angles formed by the cutout surface 51ba, 52ba, 53ba, 54ba and the cutout surface 51bb, 52bb, 53bb, 54bb of the die 51, 52, 53, 54 may be less than 180 degrees or may be 180 degrees.

According to the above-described embodiment, following operational advantages are afforded.

The taping machine 50 includes the plurality of the dies 51, 52, 53, and 54 formed with the cutouts 51b, 52b, 53b, and 54b for opening the insertion holes 51a, 52a, 53a, and 54a, and the dies 51, 52, 53, and 54 are arranged such that the cutouts 51b, 52b, 53b, and 54b are displaced from each other in the circumferential direction of the insertion holes 51a, 52a, 53a, and 54a. The side portions 18 of the adhesive tape 19 are affixed to the outer circumference of the wire rod 11 by causing the wire rod 11, to which the adhesive tape 19 is preliminary affixed such that the side portions 18 of the adhesive tape 19 stand up, to sequentially pass through the insertion holes 51a, 52a, 53a, and 54a of the dies 51, 52, 53, and 54. Thus, the surplus portion is not formed for the adhesive tape 19 affixed to the wire rod 11.

In addition, by preliminary affixing the adhesive tape 19 to the wire rod 11 such that the standing length of the first side portion 18a becomes shorter than the standing length of the second side portion 18b, it becomes possible to affix the side portion 18a having a shorter standing length to the outer circumference of the wire rod 11 by causing it to pass through the insertion hole 51a of the single die 51. Thus, the number of the dies can be minimized, and so, an increase in size of the taping machine 50 is suppressed.

Embodiments of this invention were described above, but the above embodiments are merely examples of applications of this invention, and the technical scope of this invention is not limited to the specific constitutions of the above embodiments.

This application claims priority based on Japanese Patent Application No.2023-24908 filed with the Japan Patent Office on Feb. 21, 2023, the entire contents of which are incorporated into this specification.

1. A winding device comprising:
a winding machine configured to wind a wire rod to form a coil; and
a taping machine configured to affix an adhesive tape to the wire rod, wherein
a winding step by the winding machine and a taping step by the taping machine are repeatedly performed,
the taping machine includes:
a plurality of dies respectively formed with insertion holes through which the wire rod, to which the adhesive tape is preliminary affixed such that a side portion of the adhesive tape stands up from the wire rod, is passed; and
cutouts respectively formed in the plurality of dies so as to open the insertion holes, the cutout being configured to allow entry of the side portion of the adhesive tape, wherein
the plurality of dies are arranged such that the insertion holes are linked continuously in a length direction of the wire rod and such that the cutouts are displaced from each other in a circumferential direction of the insertion holes, and
the side portion of the adhesive tape is affixed to an outer circumference of the wire rod by relatively moving the wire rod and the plurality of dies, and by causing the wire rod, to which the adhesive tape is preliminary affixed, to sequentially pass through the insertion holes of the plurality of dies.

2. (canceled)

3. (canceled)

4. (canceled)

5. (canceled)

6. (canceled)

7. (canceled)

8. (canceled)

9. A winding method comprising:
a winding step of winding a wire rod to form a coil; and
a taping step of affixing an adhesive tape to the wire rod, wherein
the winding step and the taping step are repeatedly performed,
the taping step includes:
a tape preliminary-affixing step of preliminary affixing the adhesive tape to the wire rod such that both side portions of the adhesive tape stand up from the wire rod;
a first affixing step of affixing a first side portion of the adhesive tape to an outer circumference of the wire rod by causing the wire rod, to which the adhesive tape is preliminary affixed, to pass through an insertion hole formed in an upstream-side die; and
a second affixing step of affixing a second side portion of the adhesive tape on the first side portion, which is affixed to the outer circumference of the wire rod, by causing the wire rod, which is passed through the upstream-side die and to which the adhesive tape is preliminary affixed, to pass through an insertion hole formed in a downstream-side die.

10. The winding method according to claim 9, wherein
in the tape preliminary-affixing step, the adhesive tape is preliminary affixed to the wire rod such that a standing length of the first side portion becomes shorter than a standing length of the second side portion,
in the first affixing step, the wire rod, to which the adhesive tape is preliminary affixed, is caused to pass through the insertion hole of the single upstream-side die, and
in the second affixing step, the wire rod, to which the adhesive tape is preliminary affixed, is caused to sequentially pass through the insertion holes of a plurality of the downstream-side dies.

11. The winding method according to claim 9, wherein
the insertion holes of the upstream-side die and the downstream-side die are formed to have a circular cross-sectional shape, the insertion holes being formed such that a diameter is reduced toward a moving direction of the wire rod,
in the tape preliminary-affixing step, the adhesive tape is preliminary affixed to the wire rod such that a standing length of the first side portion becomes shorter than a standing length of the second side portion, and
in the first affixing step, the first side portion of the adhesive tape is affixed to the outer circumference of the wire rod by an inner circumference of the insertion hole, and the second side portion of the adhesive tape enters and passes through a cutout, the cutout being formed in the upstream-side die so as to open the insertion hole.

12. The winding method according to claim 11, wherein
in the second affixing step, the wire rod, to which the adhesive tape is preliminary affixed, is caused to sequentially pass through the insertion holes of a plurality of the downstream-side dies.

13. A coupling coil manufactured by the winding method according to claim 9, the coupling coil being formed of a plurality of coils connected by a crossover wire, wherein
in the taping step, the adhesive tape is affixed to a portion of the wire rod that forms the crossover wire.

14. The winding device according to claim 1,
further comprising a tape preliminary-affixing machine configured to preliminary affix the adhesive tape on the wire rod, wherein
the tape preliminary-affixing machine is configured to preliminary affix the adhesive tape to the wire rod such that both side portions of the adhesive tape stand up from the wire rod, and
the taping machine is configured to affix a first side portion of the adhesive tape to an outer circumference of the wire rod by causing the wire rod, to which the adhesive tape is preliminary affixed, to pass through an insertion hole formed in an upstream-side die.

15. The winding device according to claim 14, wherein
the taping machine is configured to affix a second side portion of the adhesive tape on the first side portion, which is affixed to the outer circumference of the wire rod, by causing the wire rod, which is passed through the upstream-side die and to which the adhesive tape is preliminary affixed, to pass through an insertion hole formed in a downstream-side die.
